(19) United States
(12) Patent Application Publication
(10) Pub. No.: US 2011/0195330 A1
(43) Pub. Date: Aug. 11, 2011

(54) FUEL CELL AND ELECTRONIC DEVICE

(75) Inventors: Kazuaki Fukushima, Kanagawa (JP); Tadashi Senoo, Tokyo (JP); Mamoru Hosoya, Kanagawa (JP); Jusuke Shimura, Kanagawa (JP)

(73) Assignee: SONY CORPORATION, Tokyo (JP)

(21) Appl. No.: 13/122,842

(22) PCT Filed: Oct. 14, 2009
(86) PCT No.: PCT/JP2009/067771

§ 371 Date: Apr. 6, 2011

(30) Foreign Application Priority Data
Oct. 17, 2008 (JP) 2008-268839

(51) Int. Cl. H01M 8/04

(52) U.S. Cl. 429/442

(57) ABSTRACT

Provided is a fuel cell capable of stopping, during abnormal heat generation, a supply of fuel and/or air, and preventing additional abnormal heat generation. In an electrode structure (a heat generation section), a fusible porous film is disposed between a cathode electrode and a cathode-side exterior member, and a fusible porous film is disposed between an anode electrode and an anode-side exterior member. The fusible porous films and may be made of resin having a low melting point and being not soluble in fuel (methanol), or may be made of a combination of a porous film and polyolefin wax with a low melting point. When abnormal heat generation occurs in the fuel cell 1, the fusible porous films and are melted by heat, and pores formed thereto disappear so that a supply of fuel and/or air can be cut off without fail.

### CROSS REFERENCE TO RELATED APPLICATIONS

The present application is a National Stage of International Application No. PCT/JP2009/067771 filed on Oct. 14, 2009, which claims priority to Japanese Patent Application No. 2008-268839 filed on Oct. 17, 2008, the entire contents of which are being incorporated herein by reference.

### BACKGROUND

A fuel cell has the configuration in which an electrolyte is provided between an anode electrode (fuel electrode) and a cathode electrode (oxygen electrode). The anode electrode is supplied with fuel, and the cathode electrode is supplied with an oxidizing agent. At the time of supply, an oxidation-reduction reaction of causing oxidation of the fuel by the oxidizing agent occurs so that chemical energy possessed by the fuel is converted into electric energy.

With such a fuel cell, when crossover occurs due to an excessive supply of the fuel as a result of any failure of a fuel supply system, or when a short circuit occurs between the anode electrode and the cathode electrode due to an excessive supply of the fuel, there is a possibility of causing abnormal heat generation. Such an abnormal heat generation of a fuel cell is a cause of failure of electronic device including the fuel cell.

Previously proposed is to adjust the concentration of fuel in a fuel cell of vaporization type that supplies the fuel in the gaseous form, for example, by including a hydrophilic polymeric swelling film at an opening portion of a fuel supply section (e.g., refer to Patent Literature 1.). Citation list

### Patent Literature

Patent Literature 1: Japanese Unexamined Patent Publication No. 2006-269126

### SUMMARY

The present disclosure relates to a fuel cell provided with an electrode structure in which an electrolyte film is provided between an anode electrode and a cathode electrode, and to an electronic device using the fuel cell.

The previous technology described in Patent Literature 1 indeed has a function of preventing excessive supply of fuel by reducing the spreading speed of the fuel as a result of the gelation of the polymeric swelling film during an increase of temperature (abnormal heat generation) inside of the fuel cell. However, the effects of preventing the abnormal heat generation are not enough because the supply of the fuel is not able to be stopped completely.

The disclosure is proposed in consideration of such shortcomings, and an object thereof is to provide a fuel cell that can cut off without fail a supply of fuel and/or air at the time of abnormal heat generation, and an electronic device including the fuel cell.

A fuel cell according to an example embodiment of the disclosure includes an electrode structure (a heat generation section) including an electrolyte film between an anode electrode and a cathode electrode. In the electrode structure, a fusible porous film is provided either one or both on an anode electrode side not provided with the electrolyte film in the electrode structure and on a cathode electrode side not provided with the electrolyte film therein.

An electronic device according to an example embodiment of the disclosure includes the fuel cell of the disclosure described above.

In the fuel cell according to the example embodiment of the disclosure, the fusible porous film is provided either one or both on an anode electrode side not provided with the electrolyte film in the electrode structure and on a cathode electrode side not provided with the electrolyte film therein. With such a configuration, when abnormal heat generation occurs in the electrode structure (the heat generation section), the fusible porous film is melted and deformed so that pores formed thereto disappear. The passage of oxygen (air) or fuel to the electrode structure is thus blocked thereby. As a result, a supply of fuel and/or air to the electrode structure side is cut off. On the other hand, at the time of normal heat generation, the fusible porous film simply allows the fuel and/or air to pass therethrough.

According to the fuel cell of the example embodiment of the disclosure, the fusible porous film is provided either one or both on an anode electrode side not provided with the electrolyte film in the electrode structure and on a cathode electrode side not provided with the electrolyte film therein so that a supply of fuel and/or air can be cut off without fail during abnormal heat generation. Such a configuration thus prevents additional abnormal heat generation, can increase the level of safety of the fuel cell, and can increase the level of safety also of an electronic device including the fuel cell.

Additional features and advantages are described herein, and will be apparent from the following Detailed Description and the figures.

### BRIEF DESCRIPTION OF FIGURES

FIG. 1 is a diagram of a fuel cell in a first example embodiment of the disclosure, showing the configuration thereof.

FIG. 2 is a diagram of a fusible porous film, showing an example of structure thereof, and the state thereof after melting.

FIG. 3 is a diagram of a fuel cell in a second example embodiment of the disclosure, showing the configuration thereof

FIG. 4 is a diagram showing the configuration in a modified example 1.

FIG. 5 is a diagram showing the configuration in a modified example 2.

FIG. 6 is a diagram showing the configuration in a modified example 3.

FIG. 7 is a diagram showing the configuration in a modified example 4.

FIG. 8 is a diagram showing the configuration in a modified example 5.

FIG. 9 is a diagram showing the configuration in a modified example 6.

FIG. 10 is a diagram of an electronic device, showing the configuration thereof.

### DETAILED DESCRIPTION

In the below, example embodiments of the disclosure will be described in detail by referring to the accompanying drawings.

### First Example Embodiment

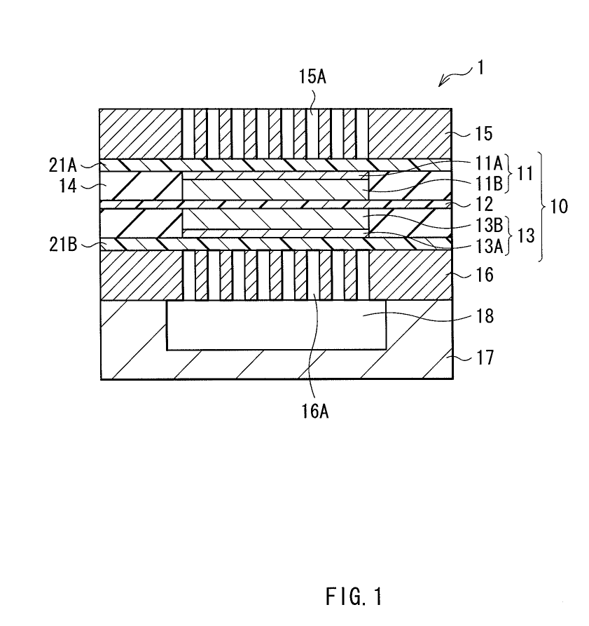

FIG. 1 is a diagram of a fuel cell in a first example embodiment of the disclosure, showing the configuration thereof This fuel cell 1 is for use in a mobile electronic device, a notebook personal computer, or others as will be described later, and is provided with an electrode structure 10 functioning as a heat generation section, for example. The electrode structure 10 is a DMFC in which an electrolyte film 12 is provided between a cathode electrode (air electrode) 11 and an anode electrode (fuel electrode) 13, for example. The cathode electrode 11 is provided, on the outer side, with a cathode-side exterior member 15, and the anode electrode 13 is provided, on the outer side, with an anode-side exterior member 16.

The cathode electrode 11 is a result of forming a catalyst layer 11B to a cathode current collector 11A, and similarly, the anode electrode 13 is a result of forming a catalyst layer 13B to an anode current collector 13A. The cathode electrode 11 and the anode electrode 13 as such are each a result of forming a catalyst layer on the surface of a carbon cloth or others, and forming a charge collector on the underside thereof. The catalyst layer includes platinum (Pt), ruthenium (Ru), or others, and the charge collector is a titanium (Ti) mesh, or others.

The electrolyte film 12 is made of a polyperfluoroalkyl sulfonic acid resin (“Nafion (trade mark)” manufactured by E. I. du Pont de Nemours and Company) or of other resin film having proton conductivity. The cathode electrode 11, the anode electrode 13, and the electrolyte film 12 are all fixedly provided by a gasket 14.

The cathode-side exterior member 15 has the thickness of 2.0 mm, for example, and is configured by an alumited aluminum (Al) plate, a titanium (Ti) plate, an acid-resistant metal plate, or others but the material thereof is not specifically restrictive. Note that the cathode-side exterior member 15 is formed with a plurality of oxygen supply holes 15A for the passage of air, i.e., oxygen, therethrough. Through such oxygen supply holes 15A, the cathode electrode 11 is provided with air, i.e., oxygen.

The anode-side exterior member 16 is made of a material with a high heat conductivity and a superior corrosion resistance such as stainless steel, aluminum (Al), or titanium (Ti). Moreover, the anode-side exterior member 16 is formed with a plurality of fuel supply holes 16A for the passage of fuel therethrough. Through such fuel supply holes 16A, the fuel is provided to the anode electrode 13.

The anode-side exterior member 16 is provided, on the outer side, with a fuel supply member 17 so as to oppose each other, and the anode-side exterior member 16 and the fuel supply member 17 as such form an internal space therebetween, which serves as a vaporizing chamber 18 for vaporization of fuel. That is, the fuel cell 1 is of vaporization type that vaporizes liquid fuel in the vaporizing chamber 18, and provides the resulting fuel in gaseous form to the anode electrode 13. The fuel supply member 17 is made of a material with a high heat conductivity and a superior corrosion resistance such as stainless steel, aluminum (Al), or titanium (Ti) similarly to the anode-side exterior member 16, for example. Moreover, the fuel supply member 17 is connected with the tip of a fuel supply tube (not shown) extending from a fuel tank (not shown) in the outside for a supply of liquid fuel to the vaporizing chamber 18. Between the anode-side exterior member 16 and the fuel supply member 17 are sealed with a sealing agent (not shown) including EPDM (ethylene propylene diene rubber), fluorine rubber, or silicone rubber so that the vaporizing chamber 18 remains air-tight. Note here that the fuel supply member 17 is not necessarily a piece of member, and alternatively, may be in the concave structure with a frame fastened to a flat-shaped member.

Moreover, in the fuel cell, the anode electrode 13 and the cathode electrode 11 in the electrode structure 10 are respectively provided with, on their sides not provided with the electrolyte film 12, fusible porous films 21A and 21B. With such a configuration, during the abnormal heat generation, this fuel cell can cut off completely a supply fuel and/or air.

To be specific, preferably, the fusible porous film 21A is provided between the cathode electrode 11 in the electrode structure 10 and the cathode-side exterior member 15, and the fusible porous film 21B is provided between the anode electrode 13 in the electrode structure 10 and the anode-side exterior member 16. With such a configuration of including the fusible porous films 21A and 21B respectively on the inner sides of the cathode-side exterior member 15 and the anode-side exterior member 16, i.e., both adjacent to the electrode structure 10, the fusible porous films 21A and 21B can directly detect the temperature of the electrode structure 10 so that cutting off of the fuel or others can be performed speedily.

The fusible porous films 21A and 21B each preferably have the thickness of 5 μm or more and 1 mm or less, for example. This is because the thickness less than 5 μm reduces the ability of cutting off the fuel and air, and the thickness more than 1 mm not only reduces the amount of fuel supply but also increases the thickness of the resulting fuel cell.

The fusible porous films 21A and 21B are each preferably made of resin not soluble in fuel (methanol), for example. To be specific, the resin with a relatively low melting point (a melting point of 130° C. or lower) is preferable such as polyethylene, polyolefin, neutralized salt of ethylene-acrylic acid copolymer, ethylene glycidyl methacrylate copolymer, nylon copolymer, and polyester copolymer. The melting point of the resin, i.e., the melting temperature of the fusible porous films 21A and 21B is preferably 60° C. or higher and 120° C. or lower, for example. This is because the cutting off of the fuel and/or air can be performed without fail at the temperature closer to 65° C., which is a boiling point of methanol being the fuel.

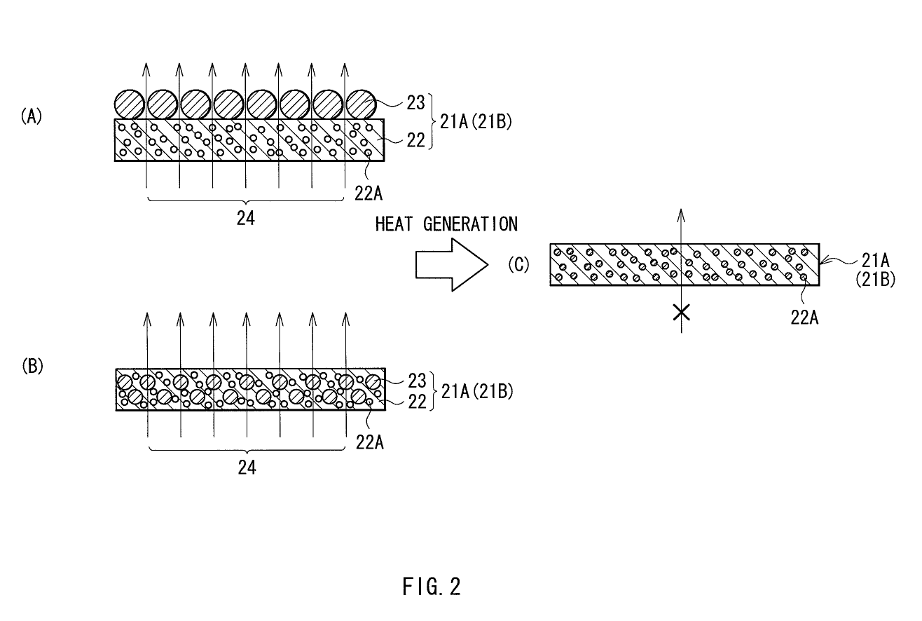

Further, the fusible porous films 21A and 21B of, for example, a combination of a porous film and polyolefin wax with a low melting point, is also possible. To be specific, the fusible porous films 21A and 21B may be each a result of blending polyolefin wax into a porous film. More preferably, exemplified may be a porous film 22 provided thereon with a polyolefin wax 23 as shown in FIG. 2(A), and the porous film 22 formed with a plurality of pores 22A and impregnated with the polyolefin wax 23 as shown in FIG. 2(B). These can be manufactured with more ease than that being a blending result. The amount of impregnation of the polyolefin wax 23 or the amount of provision thereof to the porous film 22 is adjusted based on the volume of the pores 22A formed in the porous film 22.

If this is the case, the porous film 22 is not necessarily made of resin with a low melting point, and alternatively, may be a porous film made of polyethylene, polypropylene, polyester, or fluoroplastics. The polyolefin wax 23 is exemplified by polyethylene wax. The melting temperature of the fusible porous films 21A and 21B can be changed depending on the degree of polymerization of the polyolefin wax 23 for addition, and specifically, is preferably 60° C. or higher and 120° C. or lower. This is because the cutting off of the fuel and/or air 24 can be performed without fail at the temperature closer to 65° C., which is a boiling point of methanol being the fuel.

For information, when the fusible porous films 21A and 21B are each made of resin not soluble in the fuel, although the selection of materials is limited, the cutting off of the fuel and/or air can be performed without fail during the abnormal heat generation because the resin itself has a low melting point. On the other hand, when the fusible porous films 21A and 21B are each a combination of the porous film and the polyolefin wax, the range of selection of materials becomes wide. Furthermore, by selecting polyolefin wax with a lower melting point, the fuel or others can be cut off at a lower temperature, e.g., 70° C. or lower, around 60° C., thereby being able to achieve a higher level of safety.

Such a fuel cell 1 can be manufactured in the following manner, for example.

First of all, by using the resin not soluble in the fuel as described above, the fusible porous films 21A and 21B are formed. Herein, for forming the fusible porous films 21A and 21B each in the configuration in which the porous film 22 is provided thereon with particles of the polyolefin wax 23 as shown in FIG. 2(A), the porous film 22 made of the material described above is applied (coated) with the polyolefin wax 23 described above. Alternatively, as shown in FIG. 2(B), the porous film 22 made of the material described above may be impregnated with the polyolefin wax 23.

Further, the electrolyte film 12 made of the material described above is sandwiched between the cathode electrode 11 and the anode electrode 13 for thermocompression bonding so that the electrolyte film 12 is bonded with both the cathode electrode 11 and the anode electrode 13. In this manner, the electrode structure 10 is formed. Next, the cathode electrode 1 and the anode electrode 13 as such are respectively bonded, on their outer sides, with the fusible porous films 21A and 21B by thermal fusion bonding or thermocompression bonding. Thereafter, the fusible porous film 21A on the cathode electrode 11 side is provided, on the outer side, with the cathode-side exterior member 15. Thereafter, the fuel supply holes 16A and an outer member 16B are made ready, and the fuel supply holes 16A and the outer member 16B as such are sealed together using a sealing agent, thereby forming the anode-side exterior member 16 including therein a vaporizing chamber 16C. This anode-side exterior member 16 is bonded to the fusible porous film 21B on the anode electrode 13 side by thermal fusion bonding or thermocompression bonding. As a result, the fuel cell 1 of FIG. 1 is completed.

Note that exemplified herein is the case of bonding in advance the fusible porous films 21A and 21B to the electrode structure 10. Alternatively, the films may be respectively bonded in advance to the cathode-side exterior member 15 and the fuel supply holes 16A by thermal fusion bonding or thermocompression bonding, and thereafter, the resulting structure may be bonded to the electrode structure 10.

In the fuel cell 1, the anode electrode 13 is provided with fuel (methanol), and due to the reaction therebetween, protons and electrons are generated. The protons are moved to the cathode electrode 11 via the electrolyte film 12, and then react with the electrons and oxygen so that water is generated. The reaction occurred in the anode electrode 13, the cathode electrode 11, and the electrode structure 10 in their entirety is represented by Chemical Formula 1. With such a reaction, the chemical energy of methanol being the fuel is converted into an electric energy, and the current extraction is performed from the electrode structure (the heat generation section) 10.

Anode Electrode 13: CH₃OH+H₂O→CO₂+6H⁺+6e⁻

Cathode Electrode 11: 6H⁺+(3/2)O₂+6e⁻→3H₂O

Electrode Structure 10 in its entirety: CH₃OH+(3/2)O₂→CO₂+2H₂O Chemical Formula 1

The electric energy extracted from the fuel cell 1 is made available for use as power of an electronic device (load) 100 as shown in FIG. 10. The electronic device 100 is exemplified by a mobile device such as a cell phone and a PDA (Personal Digital Assistant), a notebook book PC (Personal Computer), and others.

Herein, in the fuel cell 1 described above, the fusible porous films 21A and 21B are melted by heat when abnormal heat generation occurs due to the electrode structure 10 having a through passage of fuel or a short circuit occurred therein. Such a through passage of fuel or a short circuit is caused by crossover as a result of an excessive supply of fuel, or by formation of holes as a result of deterioration of the electrolyte film 12, for example. That is, when the fusible porous films 21A and 21B are each made of resin not soluble in the fuel, if the temperature of the electrode structure 10 reaches a value closer to the melting point of the resin, the resin starts melting and filling the pores. Moreover, in the configuration as shown in FIG. 2(A), i.e., the porous film 22 is provided thereon with the polyolefin wax 23, if the temperature of the electrode structure 10 reaches a value closer to the melting point of the polyolefin wax 23, the polyolefin wax 23 starts melting and clogging the pores 22A of the porous film 22 as shown in FIG. 2(C). Moreover, with the porous film 22 impregnated with the polyolefin wax 23 as shown in FIG. 2(B), when the temperature of the electrode structure 10 reaches a value closer to the melting point of the polyolefin wax 23, also as shown in FIG. 2(C), the polyolefin wax 23 starts melting and filling the pores 22A of the porous film 22. As such, in any of these cases, the fuel and/or air 24 is not allowed to pass through the fusible porous films 21A and 21B or the porous film 22 so that a supply of fuel and/or air can be cut off without fail. This accordingly prevents any additional abnormal heat generation so that the resulting fuel cell 1 can have a higher level of safety, and by extension, the resulting electronic device 100 can.

As such, in this example embodiment, the fusible porous films 21A and 21B are provided to the anode electrode 13 and the cathode electrode 11 in the electrode structure 10 respectively on their sides not provided with the electrolyte film 12. With such a configuration, a supply of the fuel and/or air 24 can be cut off without fail during abnormal heat generation.

Especially, the fusible porous film 21A is disposed between the cathode electrode 11 in the electrode structure 10 and the cathode-side exterior member 15, and the fusible porous film 21B is disposed between the anode electrode 13 in the electrode structure 10 and the anode-side exterior member 16. Accordingly, the fusible porous films 21A and 21B can be provided respectively on the inner sides of the cathode-side exterior member 15 and the anode-side exterior member 16, i.e., be in contact with the electrode structure 10. This thus allows the fusible porous films 21A and 21B to directly detect the temperature of the electrode structure 10 so that the fuel or others can be cut off speedily.

Moreover, especially because the fusible porous films 21A and 21B are each made of resin not soluble in fuel, or because the porous film 22 is impregnated with or provided thereon with the polyolefin wax 23, the resin can be melted and deformed during abnormal heat generation, or the pores of the porous film 22 can be made to disappear. As a result, compared with the previous polymeric swelling film, a supply of fuel or others can be cut off with better reliability.

In the below, although another example embodiment and other modified examples of the disclosure will be described, any component element same as that in the first example embodiment described above is provided with the same reference numeral, and is not described twice.

### Second Example Embodiment

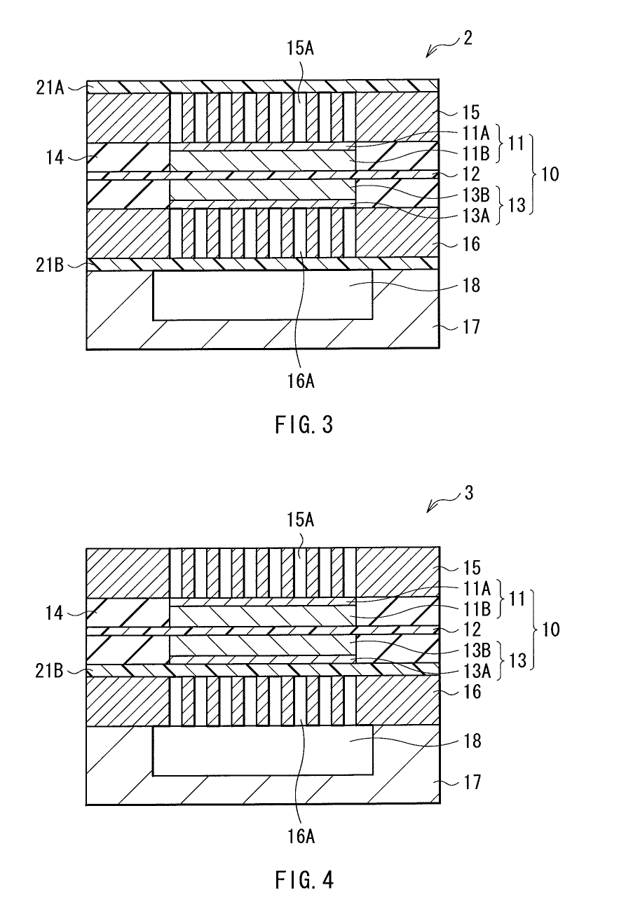

FIG. 3 is a diagram of a fuel cell 2 in a second example embodiment of the disclosure, showing the configuration thereof. This fuel cell 2 has the configuration similar to the fuel cell in the first example embodiment described above except that the fusible porous film 21A is provided on the outer side of the cathode-side exterior member 15, and the fusible porous film 21B is provided on the outer side of the anode-side exterior member 16. In this example embodiment, the fusible porous films 21A and 21B are provided at positions both away from the electrode structure 10 compared with those in the first example embodiment. In consideration thereof, for the fusible porous films 21A and 21B to detect speedily the temperature of the electrode structure 10, the material configuring the cathode-side exterior member 15 and the anode-side exterior member 16 is preferably aluminum (Al) or others with a higher heat conductivity.

Such a fuel cell 2 can be manufactured as below. First of all, in a manner similar to that in the first example embodiment, the electrode structure 10 is formed. Next, the cathode-side exterior member 15 is bonded with the fusible porous film 21A, and the resulting cathode-side exterior member 15 is then bonded to the cathode electrode 11 in such a manner that the fusible porous film 21A comes on the outer side. Thereafter, the anode-side exterior member 16 is bonded with the fusible porous film 21B, and the resulting anode-side exterior member 16 is then bonded to the anode electrode 13 in such a manner that the fusible porous film 21B comes on the outer side. Moreover, the anode-side exterior member 16 and the fuel supply member 17 are sealed together using a sealing agent so that the vaporizing chamber 18 is formed.

Also in such a fuel cell 2, similarly to the first example embodiment, when abnormal heat generation occurs in the electrode structure 10, the fusible porous films 21A and 21B are melted by heat, and the pores formed thereto thus disappear. As a result, a supply of heat and/or air is cut off so that any additional abnormal heat generation is prevented. In this example embodiment, the fusible porous films 21A and 21B are located away from the electrode structure 10 as are disposed on the outer sides of the cathode-side exterior member 15 and the anode-side exterior member 16, respectively. Therefore, although the sensitivity of detecting the temperature of the electrode structure 10 is poorer than that in the first example embodiment, there are advantages of easier assembly, and the fusible porous films 21A and 21B being replaceable after fully offering the shut down ability during the abnormal heat generation.

### Modified Example 1

A fuel cell 3 of FIG. 4 does not include the fusible porous film 21A in the first example embodiment but includes only the fusible porous film 21B therein. In such a fuel cell 3, the fusible porous film 21B is disposed between the anode electrode 13 in the electrode structure 10 and the anode-side exterior member 17. Accordingly, the fusible porous film 21B is melted and deformed during abnormal heat generation, thereby cutting off a supply of methanol being fuel before it reaches the heat generation section.

### Modified Example 2

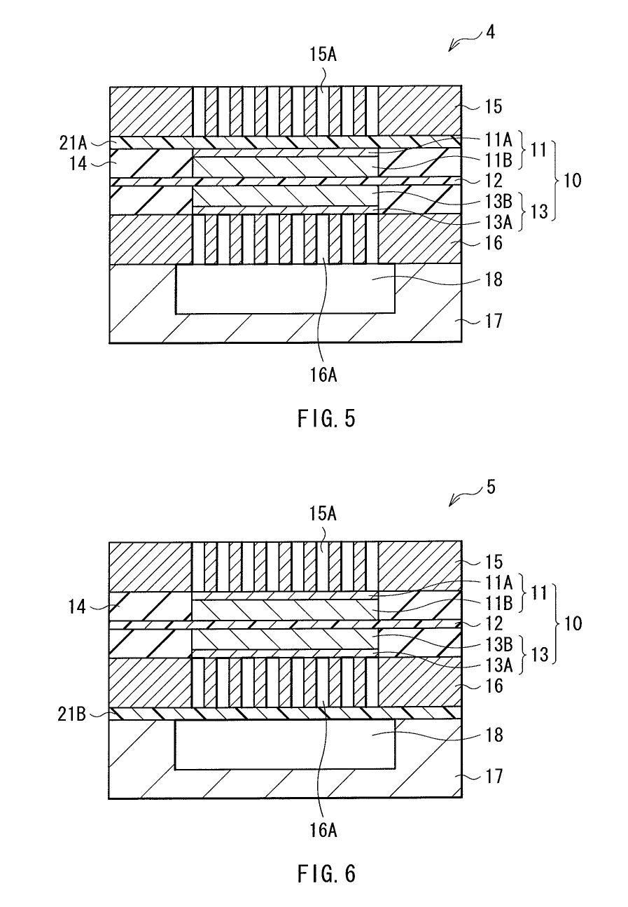

A fuel cell 4 of FIG. 5 does not include the fusible porous film 21B in the first example embodiment but includes only the fusible porous film 21A therein. In such a fuel cell 4, although fuel indeed reaches the anode electrode 13 during abnormal heat generation, a supply of air can be stopped by the fusible porous film 21A when it is melted and deformed. This is because the fusible porous film 21A is disposed between the cathode electrode 11 in the electrode structure 10 and the cathode-side exterior member 15. As a result, any reaction in progress is stopped so that any additional heat generation is prevented.

### Modified Example 3

A fuel cell 5 of FIG. 6 does not include the fusible porous film 21A in the second example embodiment but includes only the fusible porous film 21B therein, and the effects thereof are similar to those achieved in the modified example 1.

### Modified Example 4

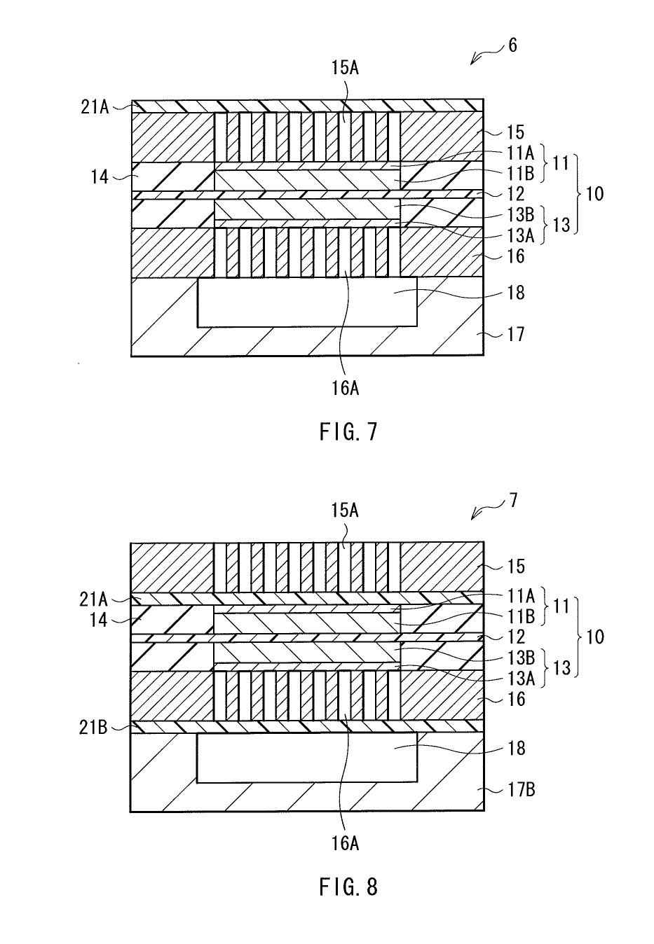

A fuel cell 6 of FIG. 7 does not include the fusible porous film 21B in the second example embodiment but includes only the fusible porous film 21A therein, and the effects thereof are similar to those achieved in the modified example 2. Moreover, the fusible porous film 21A can be replaced with another.

### Modified Example 5

A fuel cell 7 of FIG. 8 is a combination of the first example embodiment and the second example embodiment. The fusible porous film 21A is provided between the cathode electrode 11 in the electrode structure 10 and the cathode-side exterior member 15, i.e., is provided adjacent to the cathode electrode 11. At the same time, the fusible porous film 21B is provided on the outer side of the anode-side exterior member 16. With such a configuration, during abnormal heat generation, the fusible porous films 21A and 21B are both melted and deformed, thereby cutting off both a supply of air and a supply of fuel.

### Modified Example 6

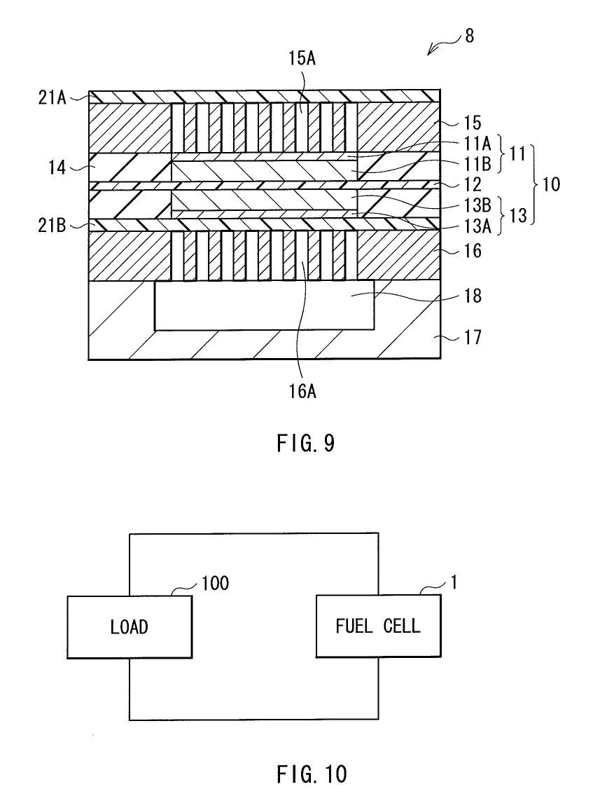

A fuel cell 8 of FIG. 9 is also a combination of the first example embodiment and the second example embodiment. The fusible porous film 21A is provided on the outer side of the cathode-side exterior member 15, and the fusible porous film 21B is provided between the anode electrode 13 in the electrode structure 10 and the anode-side exterior member 16. With such a configuration, the effects similar to those in the modified example 5 are achieved.

The disclosure is described with examples of the example embodiments, but the disclosure is not restricted to the example embodiments described above, and it is understood that numerous other modifications and variations may be devised. For example, described in the above example embodiments is the case of providing the fusible porous films 21A and 21B in the vicinity of the electrode structure 10, but this is surely not the only option as long as the fusible porous films 21A and 21B are provided either one or both on the anode electrode 13 side not provided with the electrolyte film 12 and on the cathode electrode 11 side not provided with the electrolyte film 12, and as long as the passage of oxygen (air) or fuel to the electrode structure 10 can be blocked during abnormal heat generation. As an example, a fusible porous film may be provided inside of a fuel supply tube (not shown), which is provided between a fuel tank (not shown) and the fuel supply member 17. If this is the configuration, when abnormal heat generation is observed, the fusible porous film clogs the fuel supply tube so that a supply of fuel is stopped.

Moreover, for example, specifically described in the above example embodiments are the configurations of the electrode structure 10, the fusible porous films 21A and 21B, the cathode-side exterior member 15, and the anode-side exterior member 16. Alternatively, those structure components may be configured differently or made of any other materials.

Further, the component elements described in the above example embodiments are not restricted in material, thickness, and others, and may be configured differently. Still further, the liquid fuel is not restricted to methanol used in the above example embodiments, and any other liquid fuel such as ethanol, isopropyl alcohol, butanol, and dimethyl ether will also do. If this is the case, there needs to use a material for the fusible porous films 21A and 21B not soluble in any selected liquid fuel.

Still further, in the example embodiments described above, a supply of air to the cathode electrode 11 is assumed as natural ventilation, but alternatively, the supply may be made by artificially by using a pump, for example. If this is the case, as an alternative to the air, a supply of oxygen or gas including oxygen may be made.

Still further, in the above example embodiments, although described is the case of supplying fuel in gaseous form, the disclosure is applicable also to a case of supplying liquid fuel.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims. disclosure

1-7. (canceled)

8. A fuel cell comprising:
an electrode structure including an electrolyte film between an anode electrode and a cathode electrode; and
a fusible porous film provided either one or both on an anode electrode side not provided with the electrolyte film in the electrode structure and on a cathode electrode side not provided with the electrolyte film therein.

9. The fuel cell of claim 8, wherein:
(a) on the cathode electrode side in the electrode structure, a cathode-side exterior member having an oxygen supply hole is provided;
(b) on the anode electrode side, an anode-side exterior member having a fuel supply hole is provided; and
(c) the fusible porous film is disposed at one or more positions of:
(i) between the electrode structure and the anode-side exterior member;
(ii) between the electrode structure and the cathode-side exterior member;
(iii) on an outer side of the anode-side exterior member; and
(iv) on an outer side of the cathode-side exterior member.

10. The fuel cell of claim 9, which includes:
(a) a fuel supply member disposed to oppose the anode-side exterior member; and
(b) a vaporizing chamber enclosed by the anode-side exterior member and the fuel supply member.

11. The fuel cell of claim 8, wherein the fusible porous film is made of resin which is not soluble in fuel.

12. The fuel cell of claim 8, wherein the fusible porous film is made of a porous film that is impregnated with or is disposed thereon with polyolefin wax.

13. The fuel of claim 11, wherein the fusible porous film has a melting temperature of 60° C. or higher and 120° C. or lower.

14. An electronic device comprising:
a fuel cell, wherein the fuel cell includes:
(a) an electrode structure including an electrolyte film between an anode electrode and a cathode electrode; and
(b) a fusible porous film provided either one or both on an anode electrode side not provided with the electrolyte film in the electrode structure and on a cathode electrode side not provided with the electrolyte film therein.
